(19) United States
(12) Patent Application Publication
(10) Pub. No.: US 2009/0126209 A1
(43) Pub. Date: May 21, 2009

(54) Measuring instrument

(76) Inventor: Shu-Mei Tsai, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,721

(22) Filed: Jul. 10, 2008

(30) Foreign Application Priority Data
Nov. 15, 2007 (TW) 096143331

(51) Int. Cl. G01C 15/00

(52) U.S. Cl. 33/227

(57) ABSTRACT

A measuring instrument includes a body, a horizontal optical module, and several vertical optical modules; the horizontal optical module is fixed on a top of the body, and has a brushless motor and a prism, which work together to make emitted light of the module cover a horizontal plane to form as a horizontal making line for use in construction; the body has several fixing members, which are fixedly positioned around the horizontal optical module such that horizontal central lines of every two adjacent ones of the fixing members are perpendicular to each other; the vertical optical modules are fixedly joined on the fixing members respectively such that light emission directions of every two adjacent ones of the vertical optical modules are perpendicular to each other, and light emitted from each of the vertical optical modules covers a vertical plane.

### BACKGROUND OF THE INVENTION

1. Field of the Invention

The present invention relates to a measuring instrument, more particularly one, which includes single horizontal optical modules, and several vertical optical modules; the horizontal optical module is equipped with a brushless motor and a prism, which work together to make emitted light of the module cover a horizontal plane; the vertical optical modules are joined in fixing members respectively for the measuring instrument to be easily set up and maintained.

2. Brief Description of the Prior Art

A common laser measuring instrument consists of a body, a horizontal optical module, and a brush motor installed on an upper end of the body. The brush motor is used together with transmission components such as gears and belts to rotate the horizontal optical module so that emitted light of the horizontal optical module covers a vertical or horizontal plane, and forms a shining line to serve as a mark in construction.

The above laser measuring instrument is found to have the following drawbacks:

1. The laser measuring instrument is equipped with a brush motor, and therefore has to be used together with transmission components such as gears and belts. Consequently, the laser measuring instrument is relatively large, occupying much space.

2. Carbon brushes of he brush motor has to be regularly replaced, and the transmission components can wear to cause reduction of accuracy of measurement after having been used for an extended length of time.

### SUMMARY OF THE INVENTION

It is a main object of the present invention to provide a measuring instrument to overcome the above problems.

A measuring instrument in accordance with an embodiment of the present invention includes a body, a horizontal optical module, and several vertical optical modules. The horizontal optical module is fixed on a top of the body, and has a brushless motor and a prism, which work together to make emitted light of the module cover a horizontal plane. The body has several fixing members, which are fixedly positioned around the horizontal optical module so that horizontal central lines of every two adjacent ones of the fixing members are perpendicular to each other. The vertical optical modules are fixedly joined on the fixing members respectively such that light emission directions of every two adjacent ones of the vertical optical modules are perpendicular to each other, and light emitted from each of the vertical optical modules covers a vertical plane.

Because the brushless motor is used instead of a brush motor, it isn't necessary for the user to install transmission components, e.g. gears and belts, or replace carbon brushes regularly, and there is no risk of accuracy of measurement decreasing with the components wearing. The measuring instrument can be easily adapted according to the user's need, and can be easily set up and maintained because the vertical optical modules are joined in the fixing members of the body respectively.

### BRIEF DESCRIPTION OF THE DRAWINGS

The present invention will be better understood by referring to the accompanying drawings, wherein:

FIG. 1 is a perspective view of a first preferred embodiment of the present invention,

FIG. 2 is a partial exploded perspective view of the first preferred embodiment,

FIG. 3 is a partial perspective view of the first embodiment,

FIG. 4 is a top view of the first preferred embodiment,

FIG. 5 is a top view of a second preferred embodiment, and

FIG. 6 is a top view of a third preferred embodiment.

### DETAILED DESCRIPTION OF THE PREFERRED EMBODIMENTS

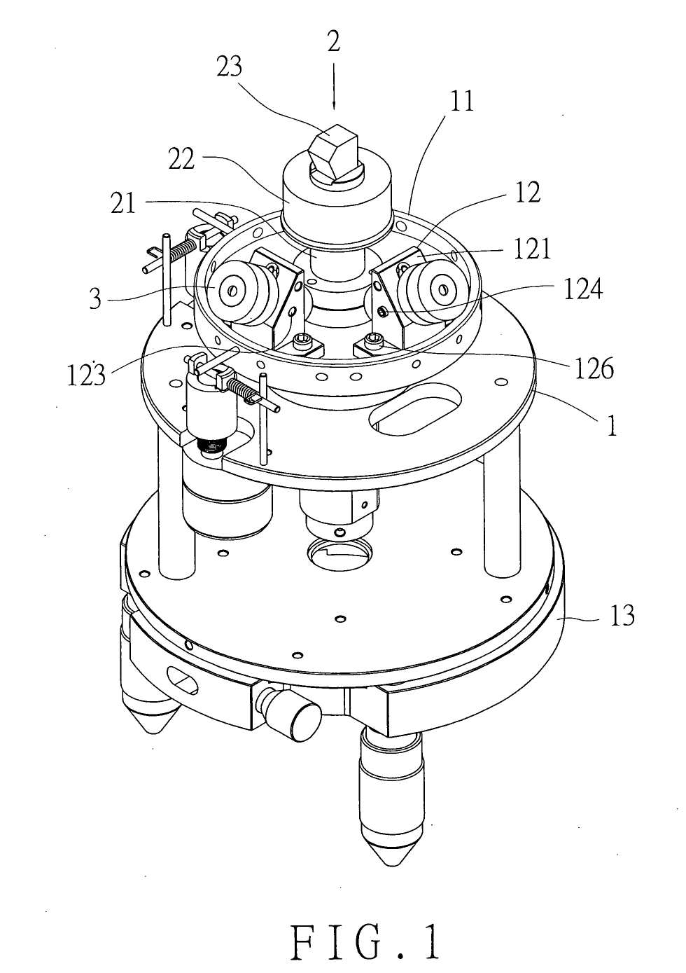

Referring to FIG. 1, a first preferred embodiment of a measuring instrument of the present invention includes a measuring instrument body 1, a horizontal optical module 2, and two vertical optical modules 3.

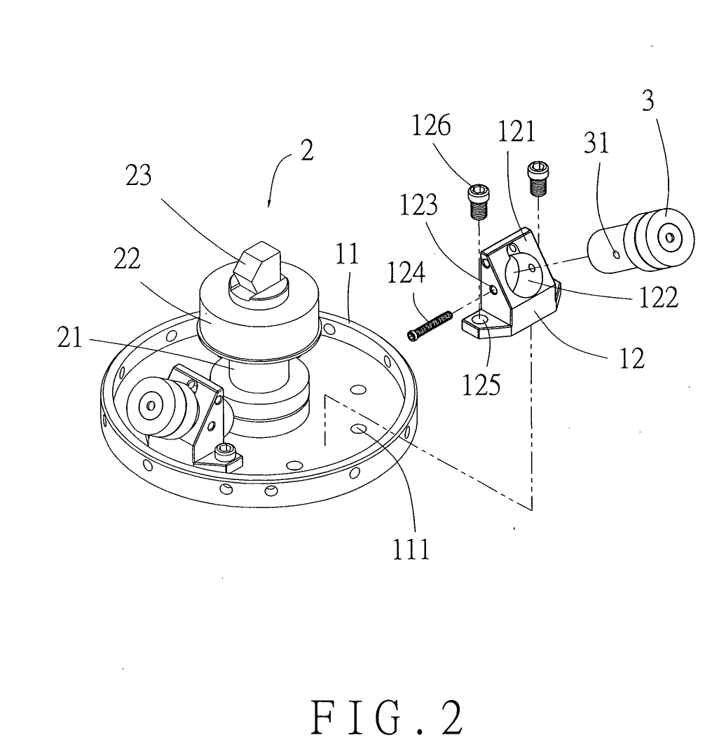

The measuring instrument body 1 has an uppermost plate 11 fixed thereon. Referring to FIG. 2 as well, the uppermost plate 11 has several pairs of threaded holes 111, which are equidistantly spaced apart on a periphery of an upper side of the uppermost plate 11. A connecting line between each pair of threaded holes 111 is perpendicular to that between an adjacent pair of threaded holes 111. The measuring instrument body 1 has two fixing members 12 fixed on the uppermost plate 11. The fixing members 12 each have an upper sloping side 121, a joining hole 122 on the upper sloping side 121, two aligned fixing holes 123 extending to the joining hole 122, and through holes 125 on a base portion thereof. The fixing members 12 are securely joined on the uppermost plate 11 with threaded fixing elements 126 being passed through the through holes 125 and the threaded holes 111 of the uppermost plate 11; the uppermost plate 11 has a horizontal radial line extending to a middle portion of each of the fixing members 12, and the horizontal radial lines extending to both the fixing members 12 are perpendicular to each other. Furthermore, an angle between extension directions of the upper sloping sides 121 of both the fixing members 12 is 90 degrees. Moreover, the measuring instrument body 1 has a supporting base member 13 to support the body 1 so that the body 1 is in an upright position.

Each of the vertical optical modules 3 can emit a visible laser light, which will form a straight indicating shining line on a plate when meeting the plane. The vertical optical modules 3 are embedded in the joining holes 122 of the fixing members 12 respectively. Each of the vertical optical modules 3 has a through hole 31, and a threaded fixing element 124 is passed through the fixing hole 123 of each said fixing member 12 and the through hole 31 of the corresponding vertical optical module 3. Thus, the vertical optical modules 3 are securely fixed in the joining holes 122 of the fixing members 12 respectively.

The horizontal optical module 2 has a light source, which can be a laser module capable of emitting visible laser light. The horizontal optical module 2 has a supporting member 21 secured on an upper end of the light source, a brushless motor 22 secured on an upper end of the supporting member 21, and a refracting lens 23, which is secured on a top of the brushless motor 22, and which will make emitted light of the light source change direction by 90 degrees to become horizontal. The refracting lens 23 can be a pentagonal prism.

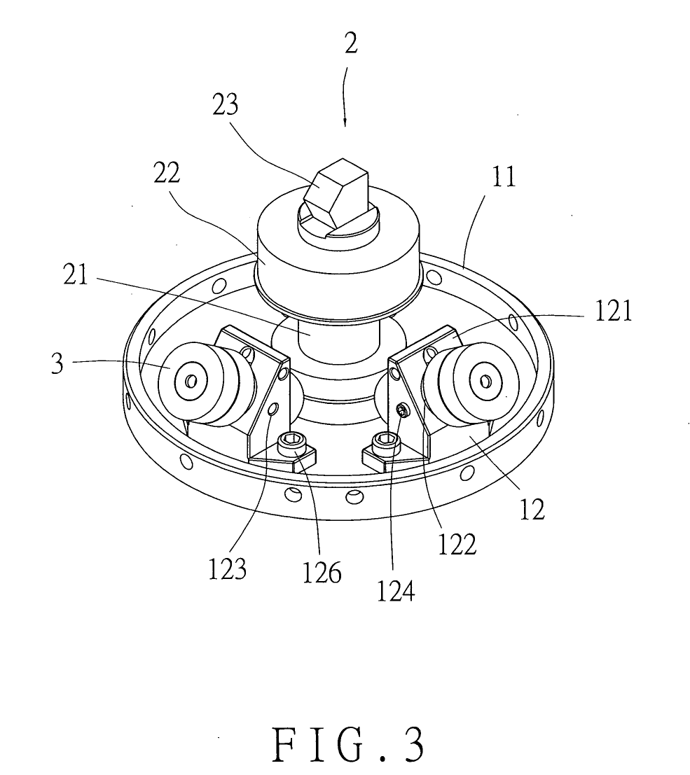

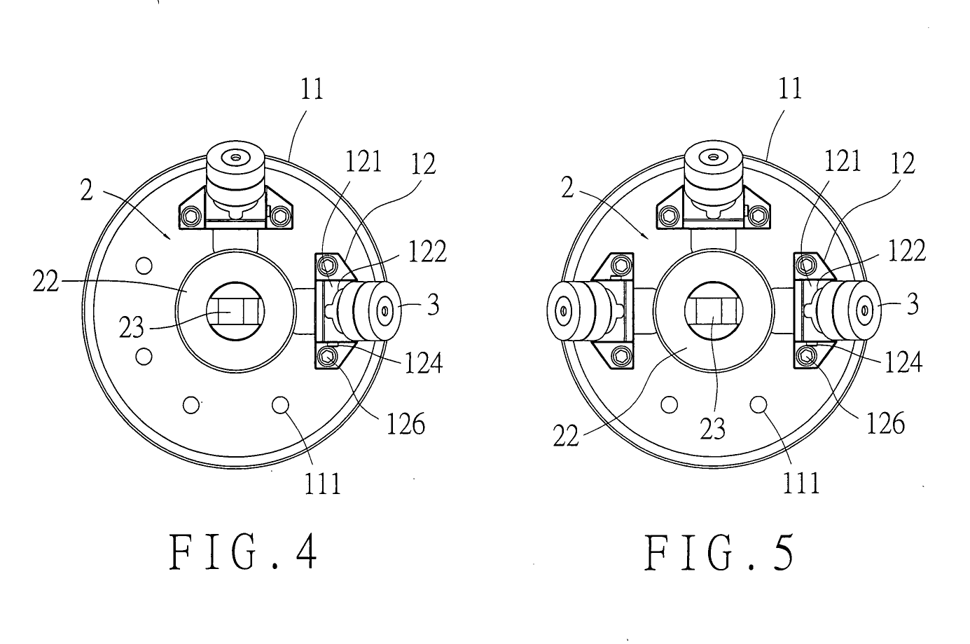

In assembly, referring to FIG. 1 to FIG. 4, the horizontal optical module 2 is installed on the middle of the uppermost plate 11 of the measuring instrument body 1 with the light source facing upwards; because light emitted from the light source will be refracted by the refracting lens 23 to travel in a horizontal direction, the light will cover a whole horizontal plane when the brush motor 22 is rotating. Next, the vertical optical modules are securely joined in the fixing members 12 respectively by means of the threaded fixing elements 124. Because extension directions of the upper sloping sides 121 of both the fixing members 12 are perpendicular to each other, light emission directions of both the vertical optical modules 3 are perpendicular to each other. Therefore, light emitted from each of the vertical optical modules 3 covers a whole vertical plane, and lights emitted from both the vertical optical modules 3 are perpendicular to each other.

In use, referring to FIG. 1 to FIG. 4, the brushless motor 22 will rotate, and light emitted from the horizontal optical module 2 will cover a horizontal plane, and form a horizontal shining line to serve as a mark in construction. And, light emitted from each of the vertical optical modules 3 covers a whole vertical plane, and lights emitted from the vertical optical modules 3 are perpendicular to each other to form vertical shining lines to serve as a mark in construction. Moreover, emitted lights of the horizontal and the vertical optical modules 2 and 3 are highly accurate.

Shown in FIG. 5 is the second preferred embodiment of a measuring instrument of the present invention, which includes three vertical optical modules 3 each securely joined in a fixing members 12 on an uppermost plate 11 of a measuring instrument body 1; thus, light emission directions of every two adjacent ones of the vertical optical modules 3 are perpendicular to each other, and lights emitted from the vertical optical modules 3 cover three vertical planes.

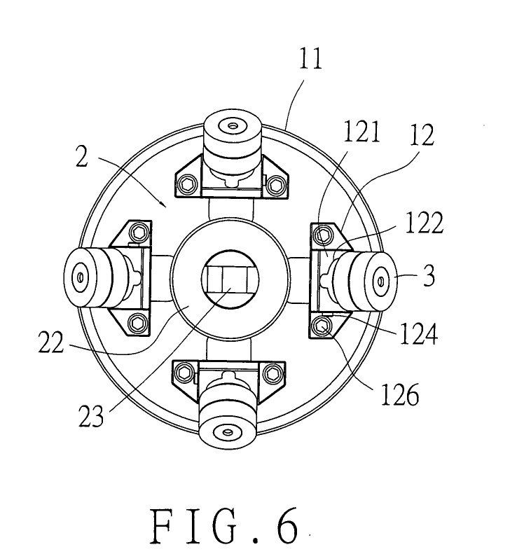

Shown in FIG. 6 is the third preferred embodiment of a measuring instrument of the present invention, which includes four vertical optical modules 3 each securely joined in a fixing members 12 on an uppermost plate 11 of a measuring instrument body 1; thus, light emission directions of every two adjacent ones of the vertical optical modules 3 are perpendicular to each other, and lights emitted from the vertical optical modules 3 cover four vertical planes.

From the above description, it can be seen that the present invention has the following advantages over the prior art:

1. The horizontal optical module of the present invention is rotated by means of a brushless motor instead of a brush motor; there is no need for gears or belts. Therefore, the present invention occupies less space, and the manufacturing cost can reduce.

2. The horizontal optical module of the present invention is used with a brushless motor therefore it isn't necessary for the user to install transmission components, e.g. gears and belts, or replace carbon brushes regularly, and there is no risk of accuracy of measurement decreasing with wearing of the components.

3. The measuring instrument can be easily adapted according to the user's need, and can be easily set up and maintained because the body includes an uppermost plate, and several fixing members joined on the uppermost plate, and the vertical optical modules can be easily joined in the fixing members respectively.

4. Light emission directions of every two adjacent ones of the vertical optical modules of the present invention are perpendicular to each other, and lights emitted from each of the vertical optical modules covers a vertical plane.

What is claimed is:

1. A measuring instrument, comprising
a measuring instrument body;
a horizontal optical module fixed on a top of the measuring instrument body;
a plurality of fixing members fixedly positioned around the horizontal optical module; the fixing members being positioned in such a manner that horizontal central lines of every two adjacent ones of the fixing members are perpendicular to each other;
a plurality of vertical optical modules, which are fixedly joined on the fixing members respectively; light emission directions of every two adjacent ones of the vertical optical modules being perpendicular to each other.

2. The measuring instrument as claimed in claim 1, wherein the measuring instrument body has an uppermost plate fixed thereon, and the fixing members are fixed on the uppermost plate.

3. The measuring instrument as claimed in claim 2, wherein the uppermost plate has a plurality of threaded holes thereon, and the fixing members each have a plurality of through holes thereon; the fixing members being fixed on the uppermost plate with threaded fixing elements being passed through the through holes and the threaded holes.

4. The measuring instrument as claimed in claim 1, wherein the measuring instrument body has a supporting base.

5. The measuring instrument as claimed in claim 1, wherein the fixing members each have an upper sloping side, and a joining hole on the upper sloping side; the vertical optical modules being embedded in the joining holes of the fixing members respectively.

6. The measuring instrument as claimed in claim 1, wherein the fixing members each have a plurality of fixing holes thereon, and the vertical optical modules each have a plurality of through holes thereon; the vertical optical modules being fixed to the fixing members with threaded fixing elements being passed through the fixing holes of the through holes.

7. The measuring instrument as claimed in claim 1, wherein the horizontal optical module has a light source, a supporting member secured on a top of the light source, a brushless motor secured on the supporting member, and a refracting lens, which is secured on a top of the brushless motor to make emitted light of the light source change direction by 90 degrees.

8. The measuring instrument as claimed in claim 7, wherein the light source is a laser module.

9. The measuring instrument as claimed in claim 7, wherein the refracting lens is a pentagonal prism.
